(19) United States
(12) Patent Application Publication
(10) Pub. No.: US 2024/0342932 A1
(43) Pub. Date: Oct. 17, 2024

(54) Method and System for Detecting the Foot-end Touchdown of Quadruped Robot

(71) Applicant: DELU DYNAMICS TECHNOLOGY (CHENG DU) CO.,LTD., Chengdu (CN)

(72) Inventors: Xuesheng Li, Chengdu (CN); Dichen Gong, Chengdu (CN); Yage Shen, Chengdu (CN)

(21) Appl. No.: 18/748,334

(22) Filed: Jun. 20, 2024

Related U.S. Application Data
(63) Continuation of application No. 17/540,168, filed on Dec. 1, 2021.

(51) Int. Cl. B25J 19/02; B25J 9/00; B25J 9/16; G06F 18/2415; G06F 18/25

(52) U.S. Cl. CPC B25J 19/02; B25J 9/0006; B25J 9/1669; G06F 18/2415; G06F 18/25

(57) ABSTRACT

The disclosure relates to a method and system for detecting the foot-end touchdown of quadruped robot, including the following steps: S1. Calculating the foot-end height above ground of each leg, and calculating the foot-end height touchdown probability based on the foot-end height above ground of each leg; Calculating the knee torque touchdown probability based on the external torque of knee joint of each leg; S2. According to the foot-end touchdown probability calculated from the gait schedule, the foot-end height and the external torque of knee joint, using the Kalman Filter to obtain the final foot-end touchdown probability of four legs; Determining the foot-end touchdown state according to the foot-end touchdown probability of four legs. The disclosure may accurately estimate the touchdown state between the foot end and the ground based on the basic sensor and fusion algorithm of the quadruped robot without deploying excess sensors at the foot end, which can solve the problem of sensor wiring; the disclosure can still obtain reliable touchdown state even in rugged or step terrain.

### CROSS-REFERENCE TO RELATED APPLICATIONS

This application is a Continuation of the U.S. application Ser. No. 17/540,168 filed on Dec. 1, 2021, and entitled “A Method and System for Detecting the Foot-end Touchdown of Quadruped Robot”, now pending, the entire disclosures of which are incorporated herein by reference.

### TECHNICAL FIELD

The disclosure relates to the technical field of robot, and more particularly to a method and system for detecting the foot-end touchdown of quadruped robot.

### BACKGROUND

Currently, there are mainly three methods to detect the foot-end touchdown state of the quadruped robot:
I. Judge the current foot-end touchdown state according to the gait schedule;
II. Deploy boolean sensors at the foot end, such as contact switches, to judge the foot-end touchdown state;
III. Deploy barometric sensors or pressure sensors at the foot end to detect the analog quantity of pressure between the foot end and the ground, and judge the foot-end touchdown state by the magnitude of the analog quantity.

The above three methods have the following defects:
Method I: The terrain is required to be flat, and the touchdown state obtained based on the schedule is not reliable in rugged or step terrain;
Method II: The sensor is difficult for installation, has short service life and is unreliable for long-term use;
Method III: The sensor is deployed at the foot end, and difficult for electrical wiring. The sensor itself has high requirements for mechanical structure and materials, and the overall deployment cost is high.

### SUMMARY

The disclosure discloses a method and system for detecting the foot-end touchdown of quadruped robot to solve the above technical problems.

The disclosure is realized by means of the following technical solution:

A method for detecting the foot-end touchdown of quadruped robot, comprising:
S1. Calculating the foot-end height above ground of each leg, and calculating the foot-end height touchdown probability based on the foot-end height above ground of each leg;
Calculating the knee torque touchdown probability based on the external torque of knee joint of each leg;
Calculating the gait schedule touchdown probability according to the gait phase;
S2. According to the foot-end touchdown probability calculated from the gait schedule, the foot-end height and the external torque of knee joint, using the Kalman Filter to obtain the final foot-end touchdown probability of four legs; Determining the foot-end touchdown state according to the foot-end touchdown probability of four legs.

Furthermore, the foot-end height touchdown probability p(c|p_{z}) is calculated with formula (1):

$$p ( c \vert {p}_{z} ) = \frac{1}{2} [ 1 + erf ( \frac{{μ}_{z} - {p}_{z}}{\sqrt{2 {σ}_{z}^{2}}} ) ] \qquad ( 1 )$$

Where, p_{z} represents the foot-end height above ground, μ_{z} represents the average foot-end height above ground at the time of touchdown and σ_{z}² represents the variance of the foot-end height above ground.

Furthermore, the knee torque touchdown probability p(c|τₖ) is calculated with formula (2):

$$p ( c \vert {τ}_{k} ) = \frac{1}{2} [ 1 + erf ( \frac{{τ}_{k} - {μ}_{τ}}{\sqrt{2 {σ}_{τ}^{2}}} ) ] \qquad ( 2 )$$

Where, τₖ represents the external torque of knee joint, μ_{τ} represents the average external torque of knee joint at the time of touchdown and σ_{τ}² represents the variance of the external torque of knee joint.

Furthermore, the gait of the quadruped robot changes cyclically; in each gait cycle, the gait phase progressively increases between 0-1; and each gait cycle is divided into a touchdown stage and a swing stage according to the leg motion state; 0≤gait phase<φ_{switch} is the touchdown stage, and φ_{switch}≤gait phase<1 is the swing stage; in the scheduled touchdown stage, the gait schedule touchdown probability p(c|φ) is calculated with formula (3):

$$p ( c \vert φ ) = \frac{1}{2} [ erf ( \frac{φ - 0}{\sqrt{2 {σ}_{φ}^{2}}} ) + erf ( \frac{{φ}_{switch} - φ}{\sqrt{2 {σ}_{φ}^{2}}} ) ] \qquad ( 3 )$$

In the scheduled swing stage, the gait schedule touchdown probability p(c|φ) is calculated with formula (4):

$$p ( c \vert φ ) = 2 + erf ( \frac{{φ}_{switch} - φ}{\sqrt{2 {σ}_{φ}^{2}}} ) + erf ( \frac{φ - 1}{\sqrt{2 {σ}_{φ}^{2}}} ) \qquad ( 4 )$$

Where, φ∈[0,1] represents the current phase in the gait cycle, φ_{switch} represents the phase at the time of inversion between the support phase and the swing phase, and σ_{φ}² represents the variance of the gait phase.

Furthermore, the final foot-end touchdown probability of four legs is calculated with recurrence formula (7):

$$\{ \begin{matrix}{\hat{x}}_{k \vert k - 1} = A {\hat{x}}_{k - 1} + {Bu}_{k} \\ {P}_{k \vert k} = {AP}_{k - 1} {A}^{T} + Q \\ {K}_{k} = \frac{{P}_{k \vert k - 1} {H}^{T}}{{HP}_{k \vert k - 1} {H}^{T} + R} \\ \hat{x} = {\hat{x}}_{k \vert k - 1} + {K}_{k} ( {z}_{k} - H {\hat{x}}_{k \vert k - 1} ) \\ {P}_{k} = ( I - {K}_{k} H ) {P}_{k \vert k - 1}\end{matrix} \qquad ( 7 )$$

$$Where , {\hat{x}}_{k + 1} = A {\hat{x}}_{k} + {Bu}_{k} + {w}_{k} , {z}_{k} = {Hx}_{k} + {v}_{k} ;$$

$${z}_{k} = \{ \begin{matrix}{z}_{1 k} \\ {z}_{2 k}\end{matrix} , H = \{ \begin{matrix}{I}_{4} \\ {I}_{4}\end{matrix} , {v}_{k} = \{ \begin{matrix}{v}_{1 k} \\ {v}_{2 k}\end{matrix} ;$$

$${\hat{x}}_{k} = \{ \begin{matrix}{P}_{1} ( c ) \\ {P}_{2} ( c ) \\ {P}_{3} ( c ) \\ {P}_{4} ( c )\end{matrix} , {u}_{k} = \{ \begin{matrix}{P}_{1} ( c \vert φ ) \\ {P}_{2} ( c \vert φ ) \\ {P}_{3} ( c \vert φ ) \\ {P}_{4} ( c \vert φ )\end{matrix} ; {z}_{1 k} = \{ \begin{matrix}{P}_{1} ( c \vert {p}_{z} ) \\ {P}_{2} ( c \vert {p}_{z} ) \\ {P}_{3} ( c \vert {p}_{z} ) \\ {P}_{4} ( c \vert {p}_{z} )\end{matrix} , {z}_{1 k} = \{ \begin{matrix}{P}_{1} ( c \vert {τ}_{k} ) \\ {P}_{2} ( c \vert {τ}_{k} ) \\ {P}_{3} ( c \vert {τ}_{k} ) \\ {P}_{4} ( c \vert {τ}_{k} )\end{matrix} ;$$

Where, Q represents the covariance matrix of noise during state transition process, R represents the covariance matrix of the observation noise;

The state transition matrix A=O₄, the control input matrix B=I₄, wₖ represents the noise during the state transition process, z₁ₖ represents the foot-end touchdown probability of four legs obtained through the probabilistic touchdown model of foot-end height, z₂ₖ represents the foot-end touchdown probability of four legs obtained through the probabilistic touchdown model of external torque of knee joint, H represents the observation matrix, and vₖ represents the observation noise:
P₁(c|φ), P₂(c|φ), P₃(c|φ), P₄(c|φ) represent the gait schedule touchdown probability of four legs;
P₁(c|p_{z}), P₂(c|p_{z}), P₃(c|p_{z}), P₄(c|p_{z}) represent the foot-end touchdown probability of four legs;
P₁(c|τₖ), P₂(c|τₖ), P₃(c|τₖ), P₄(c|τₖ) represent the knee torque touchdown probability of four legs;
P₁(c), P₂(c), P₃(c), P₄(c) represent the final foot-end touchdown probability of four legs;
\hat{x}ₖ₋₁: represents the estimated value of the posterior state at k−1 time;
\hat{x}ₖ: represents the posterior estimated value at time k of the final foot-end touchdown probability of the four legs after filter fusion;
\hat{x}_{k|k-1}: represents the prior state estimation value at time k of the intermediate calculation result of the filter;
uₖ: represents the input of the filter at time k;
P_{k|k-1}: represents the prior estimation covariance matrix at time k;
Pₖ₋₁: represents the posterior estimation covariance matrix at time k−1;
Pₖ: represents the posterior estimation covariance matrix at time k;
Kₖ: represents the Kalman Filter gain;
v₁ₖ: represents the observation noise of the probabilistic touchdown model of foot-end height;
v₂ₖ: represents the observation noise of the probabilistic touchdown model of external torque of knee joint;
O₄: represents 4×4 zero matrix;
I₄: represents 4×4 identity matrix;
I: represents identity matrix.

Wherein the center-of-mass position and body attitude of the robot are obtained by attitude solution through IMU, and the foot-end height above ground of each leg is obtained by combining the motor position fed back by the leg motor encoder.

A system for detecting the foot-end touchdown of the quadruped robot, comprising: a Kalman Filter unit, a measuring unit consisting of a foot-end height measuring module, a foot-end height touchdown probability measuring module and a knee torque touchdown probability measuring module, and an input unit consisting of a gait schedule touchdown probability calculation module; Wherein:
The foot-end height measuring module: is responsible for calculating the foot-end height above ground of each leg;
The foot-end height touchdown probability measuring module: is responsible for calculating the foot-end height touchdown probability based on the foot-end height above ground of each leg;
The knee torque touchdown probability measuring module: is responsible for calculating the knee torque touchdown probability based on the external torque of knee joint of each leg;
The gait schedule touchdown probability calculation module: is responsible for calculating the gait schedule touchdown probability of each leg;
The Kalman Filter unit: is responsible for calculating and outputting the final foot-end touchdown probability based on the input gait schedule touchdown probability, the measured foot-end height touchdown probability and the measured knee torque touchdown probability.

Compared with the prior art, the disclosure has the following beneficial effects:
1. The disclosure may accurately estimate the touchdown state between the foot end and the ground based on the basic sensor and fusion algorithm of the quadruped robot without deploying excess sensors at the foot end, which can solve the problem of sensor wiring;
2. The disclosure can still obtain reliable touchdown state even in rugged or step terrain.

### BRIEF DESCRIPTION OF DRAWINGS

The drawings illustrated herein are used to provide a further understanding of the disclosure and constitute a part of the present application. They are not intended to limit the embodiments of the disclosure.

FIG. 1 is the schematic diagram of the disclosure;

FIG. 2 is the flow chart of the disclosure.

FIG. 3 is the schematic diagram of the probabilistic touchdown model of gait schedule.

### DETAILED DESCRIPTION

In order to make the objectives, technical solutions and advantages of the disclosure more clear, the disclosure will be described in further detail below with reference to embodiments and drawings. The illustrative embodiments of the disclosure and their description are intended to explain the disclosure and not intended to limit the disclosure.

The method disclosed in the disclosure for detecting the foot-end touchdown of quadruped robot, comprises:
S1. Calculating the foot-end height above ground of each leg, and calculating the foot-end height touchdown probability based on the foot-end height above ground of each leg;
Calculating the knee torque touchdown probability based on the external torque of knee joint of each leg;
Calculating the gait schedule touchdown probability according to the gait phase;
S2. According to the foot-end touchdown probability calculated from the gait schedule, the foot-end height and the external torque of knee joint, using the Kalman Filter to obtain the final foot-end touchdown probability of four legs; Determining the foot-end touchdown state according to the foot-end touchdown probability of four legs.

The system disclosed in the disclosure for detecting the foot-end touchdown of the quadruped robot, comprises: a Kalman Filter unit, a measuring unit consisting of a foot-end height measuring module, a foot-end height touchdown probability measuring module and a knee torque touchdown probability measuring module, and an input unit consisting of a gait schedule touchdown probability calculation module; Wherein:
The foot-end height measuring module: is responsible for calculating the foot-end height above ground of each leg;
The foot-end height touchdown probability measuring module: is responsible for calculating the foot-end height touchdown probability based on the foot-end height above ground of each leg;
The knee torque touchdown probability measuring module: is responsible for calculating the knee torque touchdown probability based on the external torque of knee joint of each leg;
The gait schedule touchdown probability calculation module: is responsible for calculating the gait schedule touchdown probability of each leg;
The Kalman Filter unit: is responsible for calculating and outputting the final foot-end touchdown probability based on the input gait schedule touchdown probability, the measured foot-end height touchdown probability and the measured knee torque touchdown probability.

The disclosure discloses an embodiment based on the above method and system for detecting the foot-end touchdown of quadruped robot.

### Embodiment 1

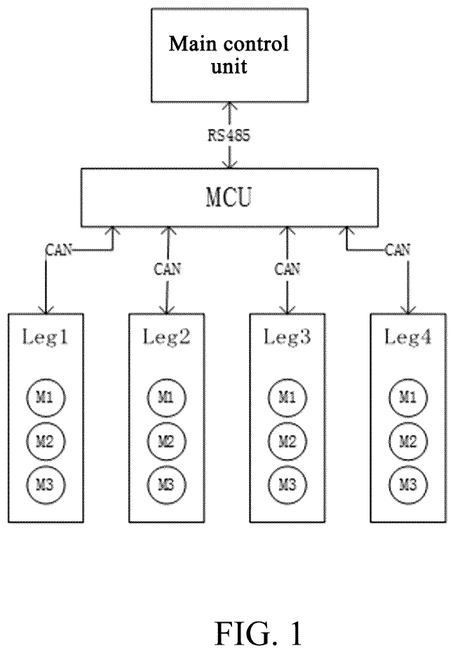

As shown in FIG. 1, in this embodiment, each leg of the quadruped robot has three degrees of freedom, and three motors are hung on the same CAN bus, which can feed back data such as motor position, speed and torque. The data conversion module is responsible for data conversion of CAN bus and RS485 bus; the main control unit communicates data with the data conversion module through RS485 bus. The main control unit can be a general main control computer.

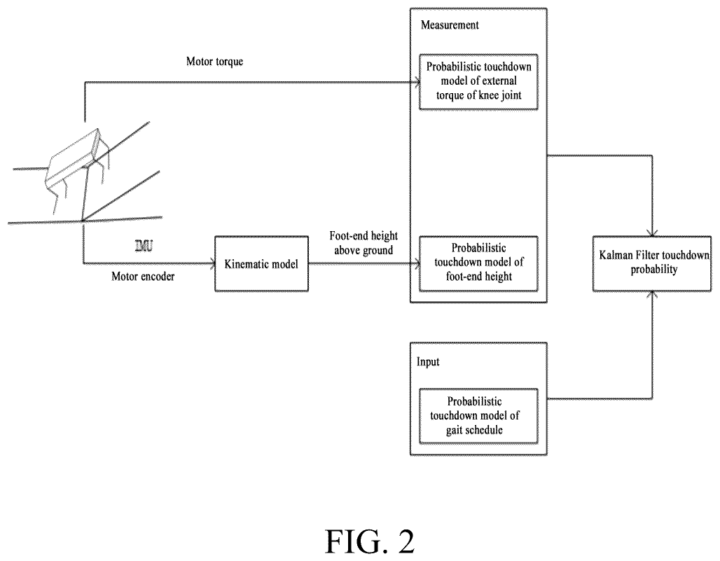

The method for detecting the foot-end touchdown of quadruped robot is described in detail in combination with FIG. 2.

I. Kinematic model: The center-of-mass position and body attitude are obtained by attitude solution through IMU, and the foot-end height above ground of each leg is obtained by combining the motor position fed back by the motor encoder, respectively: p_{z,1}, p_{z,2}, p_{z,3}, p_{z,4}.

II. Assuming that at the time of foot-end touchdown, the foot-end height above ground follows the Gaussian distribution with an average value μ_{z} and a variance σ_{z}², the probabilistic touchdown model of foot-end height is formula (1):

$$p ( c \vert {p}_{z} ) = \frac{1}{2} [ 1 + erf ( \frac{{μ}_{z} - {p}_{z}}{\sqrt{2 {σ}_{z}^{2}}} ) ] \qquad ( 1 )$$

Where, p_{z} represents the foot-end height above ground and p(c|p_{z}) represents the conditional touchdown probability with the foot-end height of p_{z}.

II. Assuming that at the time of foot-end touchdown, the external torque of knee joint follows the Gaussian distribution with an average value μ_{τ} and a variance σ_{τ}², the probabilistic touchdown model of external torque of knee joint is formula (2):

$$p ( c \vert {τ}_{k} ) = \frac{1}{2} [ 1 + erf ( \frac{{τ}_{k} - {μ}_{τ}}{\sqrt{2 {σ}_{τ}^{2}}} ) ] \qquad ( 2 )$$

Where, τₖ represents the external torque of knee joint and p(c|τₖ) represents the conditional touchdown probability with the external torque of knee joint of Tk.

### IV. Probabilistic Touchdown Model of Gait Schedule

The gait of the quadruped robot changes cyclically as scheduled in advance; in each gait cycle, the gait phase progressively increases between 0-1. Each gait cycle is divided into a touchdown stage and a swing stage according to the leg motion state; 0≤gait phase<φ_{switch} is the touchdown stage, and φ_{switch}≤gait phase<1 is the swing stage; φ_{switch} represents the phase at the time of inversion between the support phase.

For example, in the most common diagonal gait, 0≤gait phase<0.5 is the touchdown stage, and 0.5≤gait phase<1 is the swing stage.

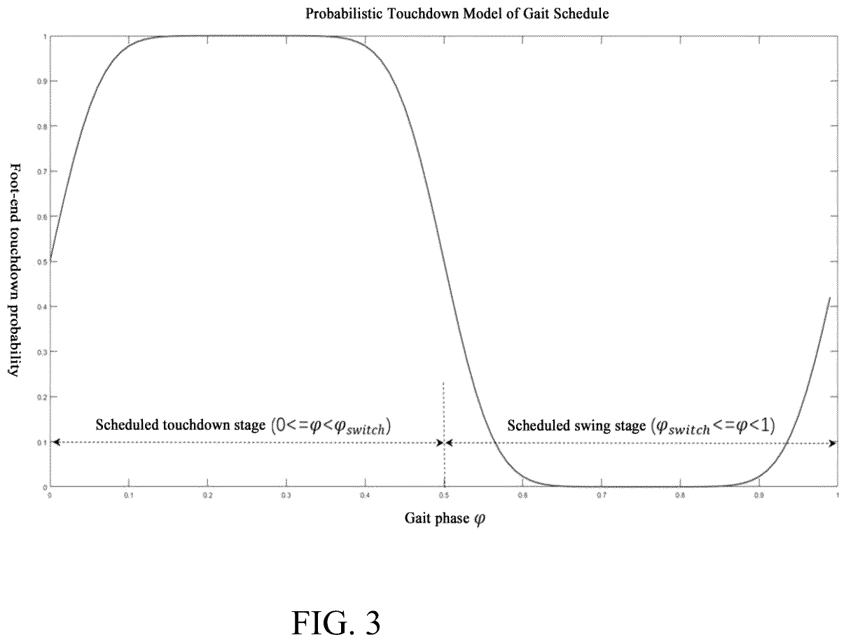

The closer the gait phase is to the midpoint of the touchdown phase, the greater the touchdown probability is. On the contrary, the farther the gait phase is to the midpoint of the touchdown phase, the lower the touchdown probability is, as shown in FIG. 3.

4.1 In the scheduled touchdown stage, the probabilistic touchdown model of gait schedule is formula (3):

$$p ( c \vert φ ) = \frac{1}{2} [ erf ( \frac{φ - 0}{\sqrt{2 {σ}_{φ}^{2}}} ) + erf ( \frac{{φ}_{switch} - φ}{\sqrt{2 {σ}_{φ}^{2}}} ) ] \qquad ( 3 )$$

4.2 In the scheduled swing stage, the probabilistic touchdown model of gait schedule is formula (4):

$$p ( c \vert φ ) = 2 + erf ( \frac{{φ}_{switch} - φ}{\sqrt{2 {σ}_{φ}^{2}}} ) + erf ( \frac{φ - 1}{\sqrt{2 {σ}_{φ}^{2}}} ) \qquad ( 4 )$$

Where, φ∈[0,1] represents the current phase in the gait cycle, φ_{switch} represents the phase at the time of inversion between the support phase and the swing phase, and σ_{φ}² represents the variance of the gait phase.

V. The gait schedule touchdown probability is taken as the system input, and the foot-end height touchdown probability and the knee torque touchdown probability are taken as the system measurements. Kalman Filter is used to obtain the foot-end touchdown probability of four legs. The specific calculation method is as follows:

1. Kalman Filter state transition equation is shown in formula (5):

$${\hat{x}}_{k + 1} = A {\hat{x}}_{k} + {Bu}_{k} + {w}_{k} \\ {\hat{x}}_{k} = \{ \begin{matrix}{P}_{1} ( c ) \\ {P}_{2} ( c ) \\ {P}_{3} ( c ) \\ {P}_{4} ( c )\end{matrix} , {u}_{k} = \{ \begin{matrix}{P}_{1} ( c \vert φ ) \\ {P}_{2} ( c \vert φ ) \\ {p}_{3} ( c \vert φ ) \\ {P}_{4} ( c \vert φ )\end{matrix} ; \qquad ( 5 )$$

Where, the state variable \hat{x}ₖ represents the final foot-end touchdown probability of four legs; the state transition matrix A=O₄; the control input matrix B=I₄, wₖ represents the noise during the state transition process, which can be considered to follow the Gaussian distribution.
uₖ: represents the input of the filter at time k;
O₄: represents 4×4 zero matrix;
I₄: represents 4×4 identity matrix;
P₁(c|φ), P₂(c|φ), P₃(c|φ), P₄(c|φ) represent the gait schedule touchdown probability of four legs;
P₁(c), P₂(c), P₃(c), P₄(c) represent the final foot-end touchdown probability of four legs;

2. Kalman Filter observation equation is shown in formula (6):

$${z}_{k} = {Hx}_{k} + {v}_{k} \qquad ( 6 )$$

$${z}_{k} = \{ \begin{matrix}{z}_{1 k} \\ {z}_{2 k}\end{matrix} , H = \{ \begin{matrix}{I}_{4} \\ {I}_{4}\end{matrix} , {v}_{k} = \{ \begin{matrix}{v}_{1 k} \\ {v}_{2 k}\end{matrix} ;$$

$${z}_{1 k} = \{ \begin{matrix}{P}_{1} ( c \vert {p}_{z} ) \\ {P}_{2} ( c \vert {p}_{z} ) \\ {P}_{3} ( c \vert {p}_{z} ) \\ {P}_{4} ( c \vert {p}_{z} )\end{matrix} , {z}_{1 k} = \{ \begin{matrix}{P}_{1} ( c \vert {τ}_{k} ) \\ {P}_{2} ( c \vert {τ}_{k} ) \\ {P}_{3} ( c \vert {τ}_{k} ) \\ {P}_{4} ( c \vert {τ}_{k} )\end{matrix} ;$$

Where, z₁ₖ represents the foot-end touchdown probability of four legs obtained through the probabilistic touchdown model of foot-end height; z₂ₖ represents the foot-end touchdown probability of four legs obtained through the probabilistic touchdown model of external torque of knee joint; H represents the observation matrix; vₖ represents the observation noise, which can be considered to follow the Gaussian distribution.
I₄: represents 4×4 identity matrix;
v₁ₖ: represents the observation noise of the probabilistic touchdown model of foot-end height;
v₂ₖ: represents the observation noise of the probabilistic touchdown model of external torque of knee joint;
P₁(c|p_{z}), P₂(c|p_{z}), P₃(c|p_{z}), P₄(c|p_{z}) represent the foot-end touchdown probability of four legs;
P₁(c|τ_{K}), P₂(c|τₖ), P₃(c|τₖ), P₄(c|τₖ) represent the knee torque touchdown probability of four legs;

3. According to the Kalman Filter state transition equation (5) and the observation equation (6), the Kalman Filter recurrence formula (7) can be obtained:

$$\{ \begin{matrix}{\hat{x}}_{k \vert k - 1} = A {\hat{x}}_{k - 1} + {Bu}_{k} \\ {P}_{k \vert k - 1} = {AP}_{k - 1} {A}^{T} + Q \\ {K}_{k =} \frac{{P}_{k \vert k - 1} {H}^{T}}{{HP}_{k \vert k - 1} {H}^{T} + R} \\ {\hat{x}}_{k} = {\hat{x}}_{k \vert k - 1} + {K}_{k} ( {z}_{k} - H {\hat{x}}_{k \vert k - 1} ) \\ {P}_{k} = ( I - {K}_{k} H ) {P}_{k \vert k - 1}\end{matrix} \qquad ( 7 )$$

Where, Q represents the covariance matrix of noise during state transition process and R represents the covariance matrix of observation noise.
\hat{x}ₖ₋₁: represents the estimated value of the posterior state at k−1 time;
\hat{x}ₖ: represents the posterior estimated value at time k of the final foot-end touchdown probability of the four legs after filter fusion;
\hat{x}_{k|k-1}: represents the prior state estimation value at time k of the intermediate calculation result of the filter;
uₖ: represents the input of the filter at time k;
P_{k|k-1}: represents the prior estimation covariance matrix at time k;
Pₖ₋₁: represents the posterior estimation covariance matrix at time k−1;
Pₖ: represents the posterior estimation covariance matrix at time k;
Kₖ: represents the Kalman Filter gain;
I: represents the identity matrix.

4. The final foot-end touchdown probability of four legs \hat{x}ₖ can be calculated with formula (7). If \hat{x}ₖ is greater than the threshold, it is considered to touch down; otherwise it is considered to not touch down.

The disclosure may accurately estimate the touchdown state between the foot end and the ground based on the basic sensor and fusion algorithm of the quadruped robot without deploying excess sensors at the foot end.

The specific embodiment above further describes the objectives, technical solutions and beneficial effect of the disclosure in detail. It should be understood that the above is only the specific embodiment of the disclosure and is not intended to limit the scope of protection of the disclosure. Any modification, equivalent replacement and improvement within the spirit and principle of the disclosure, shall be covered by the scope of protection of the disclosure.

1. A method for detecting the foot-end touchdown of quadruped robot, comprising:
S1. Calculating the foot-end height above ground of each leg, and calculating the foot-end height touchdown probability based on the foot-end height above ground of each leg;
calculating the knee torque touchdown probability based on the external torque of knee joint of each leg;
calculating the gait schedule touchdown probability according to the gait phase;
S2. According to the foot-end touchdown probability calculated from the gait schedule, the foot-end height and the external torque of knee joint, using the Kalman Filter to obtain the final foot-end touchdown probability of four legs; Determining the foot-end touchdown state according to the foot-end touchdown probability of four legs.

2. The method for detecting the foot-end touchdown of quadruped robot of claim 1, wherein the foot-end height touchdown probability p(c|p_{z}) is calculated with formula below:
$$p ( c \vert {p}_{z} ) = \frac{1}{2} [ 1 + erf ( \frac{{μ}_{z} - {p}_{z}}{\sqrt{2 {σ}_{z}^{2}}} ) ] \qquad ( 1 )$$
where, p_{z} represents the foot-end height above ground, μ_{z} represents the average foot-end height above ground at the time of touchdown and σ_{z}² represents the variance of the foot-end height above ground.

3. The method for detecting the foot-end touchdown of quadruped robot of claim 1, wherein the knee torque touchdown probability p(c|τₖ) is calculated with formula below:
$$p ( c \vert {τ}_{k} ) = \frac{1}{2} [ 1 + erf ( \frac{{τ}_{k} - {μ}_{τ}}{\sqrt{2 {σ}_{τ}^{2}}} ) ] \qquad ( 2 )$$
where, τₖ represents the external torque of knee joint, μ_{τ} represents the average external torque of knee joint at the time of touchdown and o_{τ}² represents the variance of the external torque of knee joint.

4. The method for detecting the foot-end touchdown of quadruped robot of claim 1, wherein the gait of the quadruped robot changes cyclically; in each gait cycle, the gait phase progressively increases between 0-1; and each gait cycle is divided into a touchdown stage and a swing stage according to the leg motion state;
0≤gait phase<φ_{switch} is the touchdown stage, and φ_{switch}≤gait phase<1 is the swing stage;
in the scheduled touchdown stage, the gait schedule touchdown probability p(c|φ) is calculated with formula below:
$$p ( c \vert φ ) = \frac{1}{2} [ erf ( \frac{φ - 0}{\sqrt{2 {σ}_{φ}^{2}}} ) + erf ( \frac{{φ}_{switch} - φ}{\sqrt{2 {σ}_{φ}^{2}}} ) ] \qquad ( 3 )$$
in the scheduled swing stage, the gait schedule touchdown probability p(c|φ) is calculated with formula below:
$$p ( c \vert φ ) = 2 + erf ( \frac{{φ}_{switch} - φ}{\sqrt{2 {σ}_{φ}^{2}}} ) + erf ( \frac{φ - 1}{\sqrt{2 {σ}_{φ}^{2}}} ) \qquad ( 4 )$$
where, φ∈[0,1] represents the current phase in the gait cycle, φ_{switch} represents the phase at the time of inversion between the support phase and the swing phase, and o_{φ}² represents the variance of the gait phase.

5. The method for detecting the foot-end touchdown of quadruped robot of claim 1, wherein the final foot-end touchdown probability of four legs is calculated with recurrence formula below:
$$\{ \begin{matrix}{\hat{x}}_{k \vert k - 1} = A {\hat{x}}_{k - 1} + {Bu}_{k} \\ {P}_{k \vert k - 1} = {AP}_{k - 1} {A}^{T} + Q \\ {K}_{k =} \frac{{P}_{k \vert k - 1} {H}^{T}}{{HP}_{k \vert k - 1} {H}^{T} + R} \\ {\hat{x}}_{k} = {\hat{x}}_{k \vert k - 1} + {K}_{k} ( {z}_{k} - H {\hat{x}}_{k \vert k - 1} ) \\ {P}_{k} = ( I - {K}_{k} H ) {P}_{k \vert k - 1}\end{matrix} \qquad ( 7 )$$
$$where , {\hat{x}}_{k - 1} = A {\hat{x}}_{k} + {Bu}_{k} + {w}_{k} , {z}_{k} = {Hx}_{k} + {v}_{k} ;$$
$${z}_{k} = \{ \begin{matrix}{z}_{1 k} \\ {z}_{2 k}\end{matrix} , H = \{ \begin{matrix}{I}_{4} \\ {I}_{4}\end{matrix} , {v}_{k} = \{ \begin{matrix}{v}_{1 k} \\ {v}_{2 k}\end{matrix} ;$$
$${\hat{x}}_{k} = \{ \begin{matrix}{P}_{1} ( c ) \\ {P}_{2} ( c ) \\ {P}_{3} ( c ) \\ {P}_{4} ( c )\end{matrix} , {u}_{k} = \{ \begin{matrix}{P}_{1} ( c \vert φ ) \\ {P}_{2} ( c \vert φ ) \\ {P}_{3} ( c \vert φ ) \\ {P}_{4} ( c \vert φ )\end{matrix} ; {z}_{1 k} = \{ \begin{matrix}{P}_{1} ( c \vert {p}_{z} ) \\ {P}_{2} ( c \vert {p}_{z} ) \\ {P}_{3} ( c \vert {p}_{z} ) \\ {P}_{4} ( c \vert {p}_{z} )\end{matrix} , {z}_{1 k} = \{ \begin{matrix}{P}_{1} ( c \vert {τ}_{k} ) \\ {P}_{2} ( c \vert {τ}_{k} ) \\ {P}_{3} ( c \vert {τ}_{k} ) \\ {P}_{4} ( c \vert {τ}_{k} )\end{matrix} ;$$
where, Q represents the covariance matrix of noise during state transition process, R represents the covariance matrix of the observation noise;
the state transition matrix A=O₄, the control input matrix B=I₄, wₖ represents the noise during the state transition process, z₁ₖ represents the foot-end touchdown probability of four legs obtained through the probabilistic touchdown model of foot-end height, z₂ₖ represents the foot-end touchdown probability of four legs obtained through the probabilistic touchdown model of external torque of knee joint, H represents the observation matrix, and vₖ represents the observation noise:
P₁(c|q), P₂(c|q), P₃(c|q), P₄(c|q) represent the gait schedule touchdown probability of four legs;
P₁(c|p_{z}), P₂(c|p_{z}), P₃(c|p_{z}), P₄(c|p_{z}) represent the foot-end touchdown probability of four legs;
P₁(c|τₖ), P₂(c|τₖ), P₃(c|τₖ), P₄(c|τₖ) represent the knee torque touchdown probability of four legs;
P₁(c), P₂(c), P₃(c), P₄(c) represent the final foot-end touchdown probability of four legs;
\hat{x}ₖ₋₁: represents the estimated value of the posterior state at k−1 time;
\hat{x}ₖ: represents the posterior estimated value at time k of the final foot-end touchdown probability of the four legs after filter fusion;
\hat{x}_{k|k-1}: represents the prior state estimation value at time k of the intermediate calculation result of the filter;
uₖ: represents the input of the filter at time k;
P_{k|k-1}: represents the prior estimation covariance matrix at time k;
Pₖ₋₁: represents the posterior estimation covariance matrix at time k−1;
Pₖ: represents the posterior estimation covariance matrix at time k;
Kₖ: represents the Kalman Filter gain;
v₁ₖ: represents the observation noise of the probabilistic touchdown model of foot-end height;
v₂ₖ: represents the observation noise of the probabilistic touchdown model of external torque of knee joint;
O₄: represents 4×4 zero matrix;
I₄: represents 4×4 identity matrix;
I: represents identity matrix.

6. The method for detecting the foot-end touchdown of quadruped robot of claim 1, wherein the center-of-mass position and body attitude of the robot are obtained by attitude solution through IMU, and the foot-end height above ground of each leg is obtained by combining the motor position fed back by the leg motor encoder.

7. A system for detecting the foot-end touchdown of the quadruped robot, comprising: a Kalman Filter unit, a measuring unit consisting of a foot-end height measuring module, a foot-end height touchdown probability measuring module and a knee torque touchdown probability measuring module, and an input unit consisting of a gait schedule touchdown probability calculation module; wherein:
the foot-end height measuring module: is responsible for calculating the foot-end height above ground of each leg;
the foot-end height touchdown probability measuring module: is responsible for calculating the foot-end height touchdown probability based on the foot-end height above ground of each leg;
the knee torque touchdown probability measuring module: is responsible for calculating the knee torque touchdown probability based on the external torque of knee joint of each leg;
the gait schedule touchdown probability calculation module: is responsible for calculating the gait schedule touchdown probability of each leg;
the Kalman Filter unit: is responsible for calculating and outputting the final foot-end touchdown probability based on the input gait schedule touchdown probability, the measured foot-end height touchdown probability and the measured knee torque touchdown probability.
